(19) United States
(12) Patent Application Publication
(10) Pub. No.: US 2025/0184866 A1
(43) Pub. Date: Jun. 5, 2025

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/044,941

(22) Filed: Feb. 4, 2025

Related U.S. Application Data
(63) Continuation of application No. PCT/JP2023/028082, filed on Aug. 1, 2023.
(60) Provisional application No. 63/395,101, filed on Aug. 4, 2022.

(51) Int. Cl. H04W 48/02; H04W 76/10; H04W 76/20; H04W 76/50

(52) U.S. Cl. CPC H04W 48/02; H04W 76/10; H04W 76/20; H04W 76/50

(57) ABSTRACT

In an aspect, a communication control method is used in a cellular communication system. The communication control method includes performing, by a mobile relay node, predetermined processing when the mobile relay node has connected to an intermediate relay node that is stationary without movement. The predetermined processing is one of: stopping, by the mobile relay node, a service for a user equipment under control of the mobile relay node; or operating, by the mobile relay node, as another intermediate relay node that is stationary without movement.

### RELATED APPLICATIONS

The present application is a continuation based on PCT Application No. PCT/JP2023/028082, filed on Aug. 1, 2023, which claims the benefit of U.S. Provisional Patent Application No. 63/395,101 filed on Aug. 4, 2022. The content of which is incorporated by reference herein in their entirety.

### TECHNICAL FIELD

The present disclosure relates to a communication control method used in a cellular communication system.

### BACKGROUND

The Third Generation Partnership Project (3GPP), which is a standardization project for cellular communication systems, has studied the introduction of a new relay node called Integrated Access and Backhaul (IAB) node (for example, see Non-Patent Document 1). One or more relay nodes are involved in communication between a base station and user equipment to perform relay for the communication.

### CITATION LIST

### Non-Patent Literature

Non-Patent Document 1: 3GPP TS 38.300 V17.1.0 (2022-06)

### SUMMARY

In a first aspect, a communication control method is used in a cellular communication system. The communication control method includes performing, by a mobile relay node, predetermined processing when the mobile relay node has connected to an intermediate relay node that is stationary without movement. The predetermined processing is one of: stopping, by the mobile relay node, a service for a user equipment under control of the mobile relay node; or operating, by the mobile relay node, as another intermediate relay node that is stationary without movement.

In a second aspect, a communication control method is used in a cellular communication system. The communication control method includes connecting, by a mobile relay node in an RRC idle state or an RRC inactive state, to another intermediate relay node as an intermediate relay node that is stationary without movement, when receiving an emergency call from a user equipment.

### BRIEF DESCRIPTION OF THE DRAWINGS

FIG. 1 is a diagram illustrating a configuration example of a cellular communication system according to an embodiment.

FIG. 2 is a diagram illustrating a relationship between IAB nodes, parent nodes, and child nodes.

FIG. 3 is a diagram illustrating a configuration example of a gNB (base station) according to an embodiment.

FIG. 4 is a diagram illustrating a configuration example of an IAB node (relay node) according to an embodiment.

FIG. 5 is a diagram illustrating a configuration example of user equipment (UE) according to an embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIG. 9 is a diagram illustrating an example of a first scenario according to a first embodiment.

FIG. 10 is a diagram illustrating an example of a second scenario according to the first embodiment.

FIG. 11 is a diagram illustrating an operation example according to a first operation example.

FIG. 12 is a diagram illustrating an operation example according to a second operation example.

FIG. 13 is a diagram illustrating an operation example according to a third operation example.

### DESCRIPTION OF EMBODIMENTS

A cellular communication system according to an embodiment is described with reference to the drawings. In the description of the drawings, the same or similar parts are denoted by the same or similar reference signs.

### First Embodiment

### Configuration of Cellular Communication System

A configuration example of the cellular communication system according to an embodiment will be described. In an embodiment, a cellular communication system 1 is a 5G system of the 3GPP. Specifically, a radio access scheme of the cellular communication system is New Radio (NR) being a 5G radio access scheme. Note that Long Term Evolution (LTE) may be at least partially applied to the cellular communication system 1. A future cellular communication system such as 6G may be applied to the cellular communication system 1.

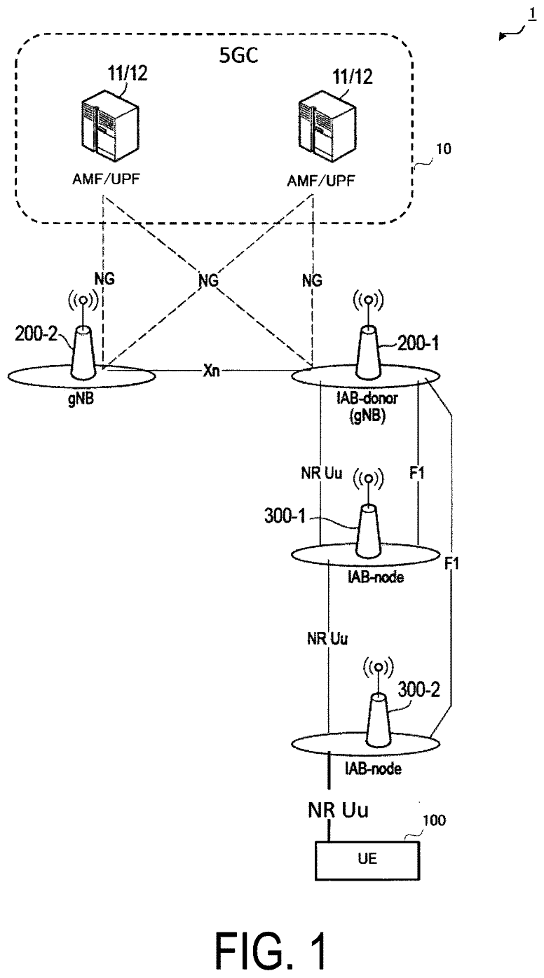

FIG. 1 is a diagram illustrating a configuration example of the cellular communication system 1 according to an embodiment.

As illustrated in FIG. 1, the cellular communication system 1 includes a 5G core network (5GC) 10, user equipment (UE) 100, base station apparatuses (hereinafter, which may also be referred to as “base stations”) 200-1 and 200-2, and IAB nodes 300-1 and 300-2. The base stations 200 may be referred to as gNBs.

Although an example in which the base stations 200 are NR base stations will be mainly described below, the base stations 200 may be LTE base stations (i.e., eNBs).

Note that, in the following description, the base stations 200-1 and 200-2 may be referred to as gNBs 200 (or base stations 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 controls various types of mobility and the like for the UE 100. The AMF 11 manages information of the area in which the UE 100 exists in by communicating with the UE 100 using Non-Access Stratum (NAS) signaling. The UPF 12 controls user data transfer, and the like.

Each gNB 200 is a fixed wireless communication node and manages one or more cells. The term “cell” is used as a term representing a minimum unit of a wireless communication area. The “cell” is also used as a term representing a function or a resource for performing wireless communication with the UE 100. One cell belongs to one carrier frequency. Hereinafter, cells and base stations may be used without distinction.

Each gNB 200 is interconnected to the 5GC 10 via an interface referred to as an NG interface. FIG. 1 illustrates two nodes of the gNB 200-1 and the gNB 200-2 connected to the 5GC 10.

Each gNB 200 may be divided into a Central Unit (CU) and a Distributed Unit (DU). The CU and the DU are interconnected via an interface called an F1 interface. An F1 protocol is a communication protocol between the CU and the DU and includes an F1-C protocol that is a control plane protocol and an F1-U protocol that is a user plane protocol.

The cellular communication system 1 supports an IAB that uses NR for the backhaul to enable wireless relay of the NR access. The donor gNB 200-1 (or a donor node, which hereinafter may be also referred to as a “donor node”) is a donor base station that is a terminal node of the NR backhaul on the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul hops.

The UE 100 is a mobile wireless communication apparatus that performs wireless communication with cells. The UE 100 may be any type of apparatus as long as the UE 100 is an apparatus that performs wireless communication with the gNBs 200 or the IAB nodes 300. For example, the UE 100 includes a mobile phone terminal or a tablet terminal, a laptop PC, a sensor or an apparatus that is provided in a sensor, a vehicle or an apparatus that is provided in a vehicle, and an aircraft or an apparatus provided in an aircraft. The UE 100 is wirelessly connected to any of the IAB nodes 300 or the gNBs 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

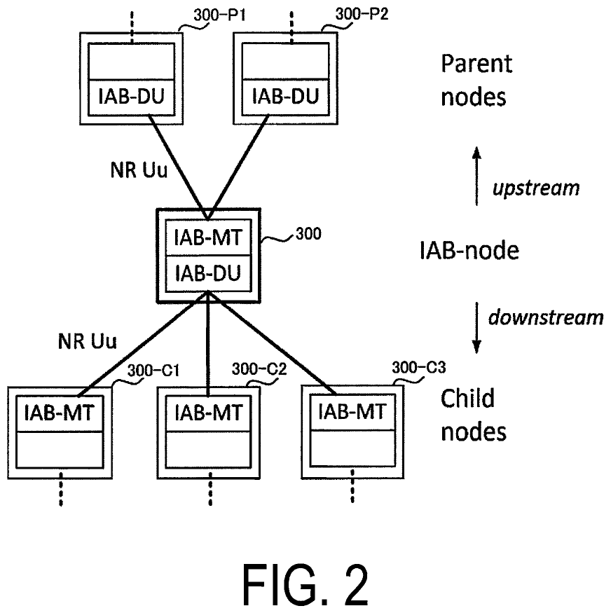

FIG. 2 is a diagram illustrating a relationship example between the IAB nodes 300, parent nodes, and child nodes.

As illustrated in FIG. 2, the IAB nodes 300 are an IAB-DU corresponding to a base station functional unit and an IAB-Mobile Termination (IAB-MT) corresponding to a user equipment functional unit, respectively.

Neighboring nodes of the IAB-MT (i.e., upper node) on an NR Uu wireless interface are referred to as “parent nodes”. The parent nodes are parent IAB nodes or DUs of the donor nodes 200. A radio link between the IAB-MT and each parent node is referred to as a backhaul link (BH link). FIG. 2 illustrates an example in which the parent nodes of the IAB nodes 300 are IAB nodes 300-P1 and 300-P2. Note that the direction toward the parent nodes is referred to as upstream. As viewed from the UE 100, the upper nodes with respect4 to the UE 100 may correspond to parent nodes.

Neighboring nodes of the IAB-DU (i.e., lower nodes) of an NR access interface are referred to as “child nodes”. The IAB-DU manages cells like the gNB 200. The IAB-DU terminates the NR Uu wireless interface connected to the UE 100 and the lower IAB nodes. The LAB-DU supports the F1 protocol for the CU of the donor node 200-1. Although FIG. 2 illustrates an example in which the child nodes of the IAB nodes 300 are IAB nodes 300-C1 to 300-C3, the child nodes of the IAB nodes 300 may include the UE 100. Note that the direction toward the child nodes is referred to as downstream.

All of the IAB nodes 300 connected to the donor node 200 via one or more hops form a Directed Acyclic Graph (DAG) topology (which may be referred to as “topology” below) rooted at the donor node 200. In this topology, the neighboring nodes of the IAB-DU on the interface are child nodes, and the neighboring nodes of the IAB-MT on the interface are parent nodes as illustrated in FIG. 2. The donor nodes 200 perform, for example, centralized management on resources, topology, and routes of the IAB topology. The donor nodes 200 are gNBs that provide network access to the UE 100 via a network of backhaul links and access links.

### Configuration of Base Station

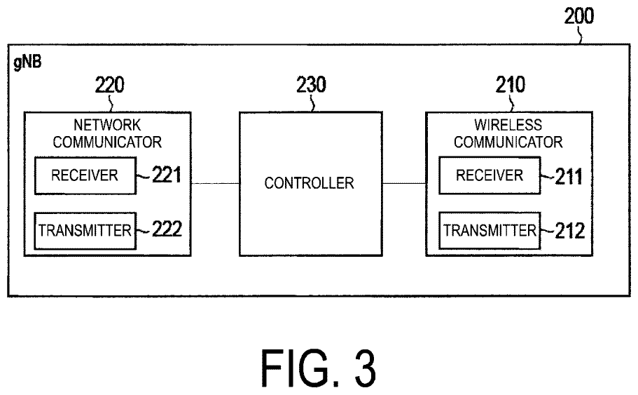

A configuration of a gNB 200 as a base station according to an embodiment will be described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB nodes 300. The wireless communicator 210 includes a receiver 211 and a transmitter 212. The receiver 211 performs various types of reception under control of the controller 230. The receiver 211 includes an antenna and converts (down-converts) a radio signal received by the antenna into a baseband signal (reception signal) and then outputs the signal to the controller 230. The transmitter 212 performs various types of transmission under control of the controller 230. The transmitter 212 includes an antenna and converts (up-converts) the baseband signal (transmission signal) output by the controller 230 into a radio signal and then transmits the signal from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from outside and outputs the reception signal to the controller 230. The transmitter 222 performs various types of transmission under control of the controller 230. The transmitter 222 transmits the transmission signal output by the controller 230 to the outside.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 230 may perform all of the processing and operations in the gNB 200 in each embodiment to be described below.

### Configuration of Relay Node

A configuration of the IAB node 300 that is a relay node (or a relay node apparatus, which may hereinafter also be referred to as a “relay node”) according to an embodiment will be described.

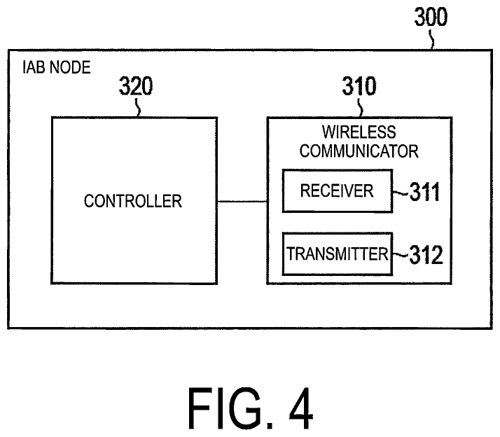

FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). A wireless communicator 310 for BH link communication and a wireless communicator 310 for access link communication may be provided separately.

The wireless communicator 310 includes a receiver 311 and a transmitter 312. The receiver 311 performs various types of reception under control of the controller 320. The receiver 311 includes an antenna and converts (down-converts) a radio signal received by the antenna into a baseband signal (reception signal) and then outputs the signal to the controller 320. The transmitter 312 performs various types of transmission under control of the controller 320. The transmitter 312 includes an antenna and converts (up-converts) the baseband signal (transmission signal) output by the controller 320 into a radio signal and then transmits the signal from the antenna.

The controller 320 performs various types of control in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of each layer described below. Note that the controller 320 may perform each processing and operation in the IAB node 300 in each embodiment to be described below.

### Configuration of User Equipment

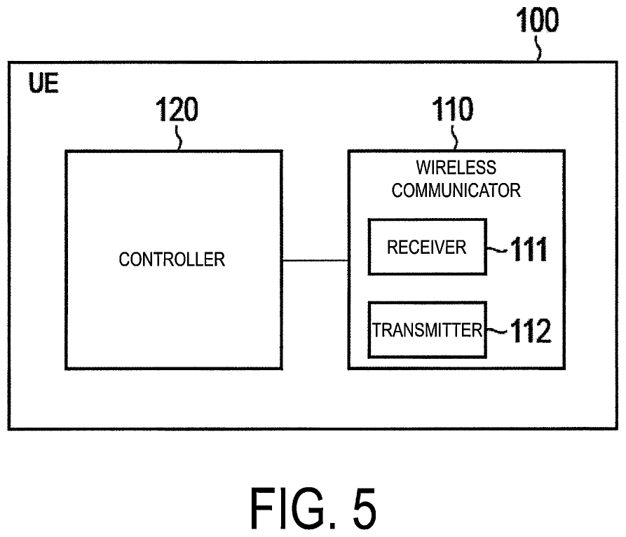

A configuration of the UE 100 that is user equipment according to an embodiment will be described. FIG. 5 is a diagram illustrating a configuration example of the UE 100. As illustrated in FIG. 5, the UE 100 includes a wireless communicator 110 and a controller 120.

The wireless communicator 110 performs wireless communication in access links, i.e., wireless communication with the gNBs 200 and wireless communication with the IAB nodes 300. The wireless communicator 110 may also perform wireless communication in sidelink, i.e., wireless communication with another piece of UE 100. The wireless communicator 110 includes a receiver 111 and a transmitter 112. The receiver 111 performs various types of reception under control of the controller 120. The receiver 111 includes an antenna and converts (down-converts) a radio signal received by the antenna into a baseband signal (reception signal) and then outputs the signal to the controller 120. The transmitter 112 performs various types of transmission under control of the controller 120. The transmitter 112 includes an antenna and converts (up-converts) the baseband signal (transmission signal) output by the controller 120 into a radio signal and then transmits the signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of each layer described below.

Note that the controller 120 may perform each processing operation in the UE 100 in each embodiment described below.

### Configuration of Protocol Stack

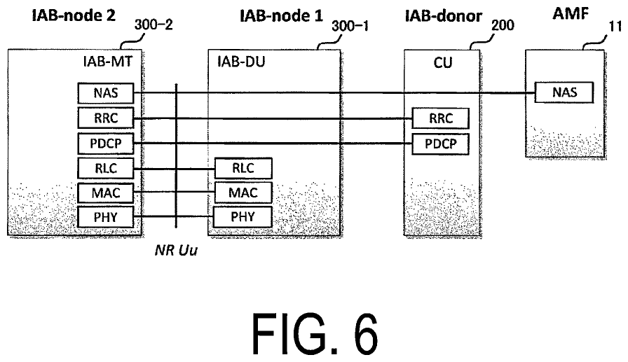

A configuration of a protocol stack according to an embodiment will be described. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access

Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through a Hybrid Automatic Repeat reQuest (HARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines uplink and downlink transport formats (transport block sizes, Modulation and Coding Schemes (MCSs)) and allocated resource blocks.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a physical channel.

The PDCP layer performs header compression/decompression, and encryption/decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, reestablishment, and release of a radio bearer. RRC signaling for various configurations is transmitted between the RRC layer of the IAB-MT of the IAB node 300-2 and the RRC layer of the donor node 200. When an RRC connection to the donor node 200 is present, the IAB-MT is in an RRC connected state. When no RRC connection to the donor node 200 is present, the IAB-MT is in an RRC idle state.

The NAS layer positioned above the RRC layer performs session management, mobility management, and the like. NAS signaling is transmitted between the NAS layer of the IAB-MT of the IAB node 300-2 and the AMF 11.

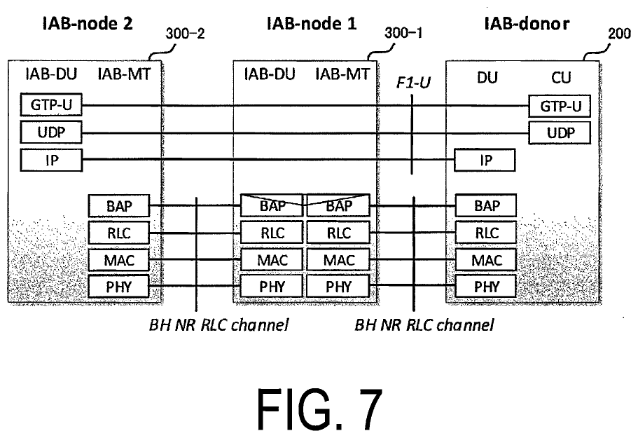

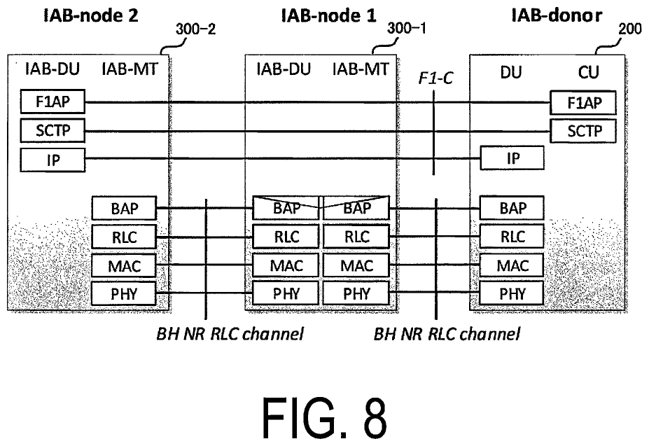

FIG. 7 is a diagram illustrating a protocol stack related to an F1-U protocol. FIG. 8 is a diagram illustrating a protocol stack related to an F1-C protocol. An example in which the donor node 200 is divided into a CU and a DU will be introduced here.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as an upper layer of the RLC layer. The BAP layer performs routing processing, and bearer mapping/demapping processing. In the backhaul, transmission of the IP layer through the BAP layer enables routing through a plurality of hops.

In each backhaul link, a Protocol Data Unit (PDU) of the BAP layer is transmitted by a backhaul RLC channel (BH NR RLC channel). Configuring a plurality of backhaul RLC channels in each BH link enables the prioritization and Quality of Service (QOS) control of traffic. Association between the BAP PDU and the backhaul RLC channel is executed by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”

An upstream direction and an uplink (UL) direction may be used without distinction. A downstream direction and a downlink (DL) direction may be used without distinction. Two Scenarios

Recently, the 3GPP has started a study for introducing mobile IAB nodes. A mobile IAB node is, for example, an IAB node that is moving. A mobile IAB node may be a movable IAB node. Alternatively, a mobile IAB node may be an IAB node having the ability to move. Alternatively, a mobile IAB node may be an IAB node that is currently stationary but is certain to move in the future (or is expected to move in the future).

By the mobile IAB node, for example, the UE 100 under the control of the mobile IAB node can receive provision of services from the mobile IAB node while moving with the movement of the mobile IAB node. For example, a user (or UE 100) riding in a vehicle can receive provision of a service via a mobile IAB node installed in the vehicle.

Note that the 3GPP also has discussed that a mobile IAB node should provide services to UE 100 without having an IAB node under its control.

On the other hand, there is an IAB node that does not move with respect to the mobile IAB node. Such an IAB node may be referred to as an intermediate IAB node. The intermediate IAB node is, for example, a non-moving IAB node. Alternatively, the intermediate IAB node may be an IAB node that is still. The intermediate IAB node may be a stationary IAB node. Alternatively, the intermediate IAB node may be a stationary (or non-moving) IAB node installed at the installation site. Alternatively, the intermediate IAB node may be an IAB node that is stationary without movement. Alternatively, the intermediate IAB node may be a fixed IAB node.

The 3GPP has studied the complexity of a mobile IAB node in each of the following two scenarios.

(First scenario) A mobile IAB node connects only to a donor node. (Second scenario) A mobile IAB node can also connect to an intermediate IAB node.

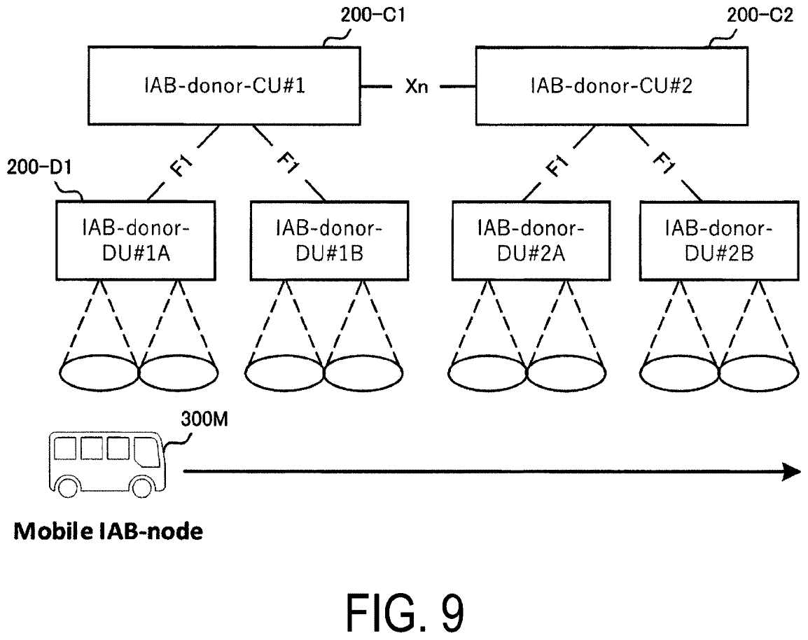

FIG. 9 is a diagram illustrating an example of the first scenario according to a first embodiment. The example of FIG. 9 indicates a mobile IAB node 300M installed on a bus and moving while connecting to each DU (DU 200-D1, etc.) of each of donor nodes 200. In the first scenario, the mobile IAB node 300M connects to the donor nodes 200 without connecting to an intermediate IAB node. “Connect only to the donor node” means connecting to the donor nodes 200 without connecting to an intermediate IAB node.

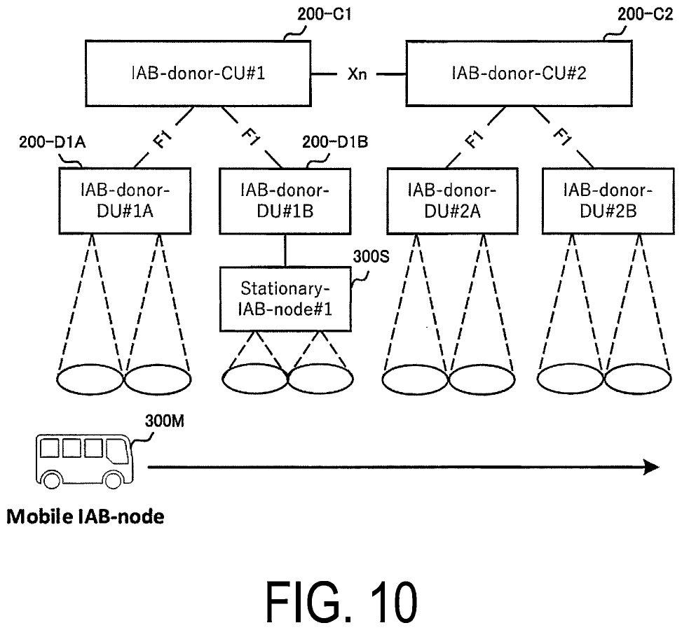

FIG. 10 is a diagram illustrating an example of the second scenario according to the first embodiment. The example of FIG. 10 indicates the mobile IAB node 300M installed on a bus and moving while connecting to each DU (DU 200-DIA, etc.) of each donor node 200 and also connecting to an intermediate IAB node 300S. The second scenario is of the mobile IAB node 300M being connectable to the donor node 200 and to the intermediate IAB node 300S.

The 3GPP has some opinions that the first scenario is less complex than the second scenario, and conversely, that the first scenario is more complex than the second scenario.

The first embodiment will describe the first scenario. In the first scenario, for example, when the mobile IAB node 300M cannot be connected to the donor node 200, if the mobile IAB node 300M is considered to have been disconnected from the network, the mobile IAB node 300M is assumed to be incapable of providing a service to the UE 100 under its control.

On the other hand, when the mobile IAB node 300M has connected to the intermediate IAB node 300S, the first scenario becomes meaningless if the mobile IAB node 300M can operate as a mobile IAB node as when the mobile IAB node 300M connects to the donor node 200.

For this reason, the mobile IAB node 300M may be unable to operate as a mobile IAB node when having connected to the intermediate IAB node 300S. In this case, the mobile IAB node 300M may operate as an intermediate IAB node (i.e., a fixed IAB node) rather than as a mobile IAB node. Alternatively, the mobile IAB node 300M may operate as the UE 100 and be allowed to connect to a network, such as for an OAM-connection.

In this way, even in the first scenario, the mobile IAB node 300M may be allowed to connect to the intermediate IAB node 300S.

However, when the mobile IAB node 300M has connected to the intermediate IAB node 300S, what kind of service can be provided to the UE 100 under the control of the mobile IAB node 300M may be an issue. Providing the same service to the UE 100 as when the mobile IAB node 300M has connected to the donor node 200 would make the first scenario meaningless as described above.

Therefore, the first embodiment aims at appropriately restricting services for the UE 100 under the control of the mobile IAB node 300M when the mobile IAB node 300M has connected to the intermediate IAB node 300S.

Three operation examples according to the first embodiment will be described in order below.
(1.1) First operation example: The mobile IAB node 300M stops services for the UE 100 when having connected to the intermediate IAB node 300S.
(1.2) Second operation example: The mobile IAB node 300M operates as an intermediate IAB node when having connected to the intermediate IAB node 300S
(1.3) Third operation example: Upon receiving an emergency call from the UE 100, the mobile IAB node 300M in the RRC idle state or the RRC inactive state connects to the intermediate IAB node 300S as an intermediate IAB node.

### (1.1) First Operation Example

In the first operation example, when the mobile IAB node 300M has connected to the intermediate IAB node 300S, the service for the UE 100 is stopped. To be more specific, when a mobile relay node (for example, the mobile IAB node 300M) has connected to an intermediate relay node that is stationary without movement (for example, the intermediate IAB node 300S), predetermined processing is performed. In the first operation example, the predetermined processing is that the mobile relay node stops services for user equipment (for example, the UE 100) under the control of the mobile relay node.

As described above, for example, when the mobile IAB node 300M has connected to the intermediate IAB node 300S, services for the UE 100 under the control of the mobile IAB 300M can be stopped, so services for the UE 100 can be appropriately restricted.

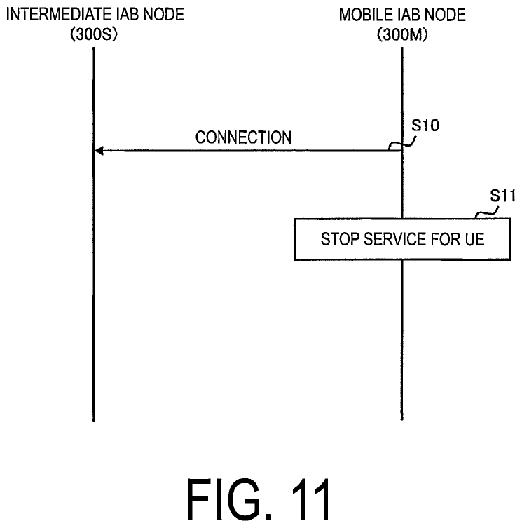

FIG. 11 is a diagram illustrating an operation example according to the first operation example.

As illustrated in FIG. 11, the mobile IAB node 300M is connected to the intermediate IAB node 300S in step S10. Cases where the mobile IAB node 300M connects to the intermediate IAB node 300 are, for example, as follows.

First, the IAB-MT of the mobile IAB node 300M in the RRC idle state may transmit an RRC setup request (RRCSetupRequest) message to the IAB-DU of the intermediate IAB node 300S to connect to the intermediate IAB node 300S by performing an RRC connection establishment procedure.

Second, the IAB-MT of the mobile IAB node 300M in the RRC inactive state may connect to the intermediate IAB node 300S by transmitting an RRC recovery request (RRCResumeRequest) message to the IAB-DU of the intermediate IAB node 300S and performing an RRC connection recovery (RRC connection resume) procedure.

Third, after detecting a Radio Link Failure (RLF), the IAB-MT of the mobile IAB node 300M may connect to the intermediate IAB node 300S by transmitting an RRC re-establishment request (RRCReestablishmentRequest) message to the IAB-DU of the intermediate IAB node 300S and performing an RRC connection re-establishment procedure.

Fourth, the IAB-MT of the mobile IAB node 300M connected to the donor node 200 may connect to the intermediate IAB node 300S through a handover (or migration) by receiving an RRC reconfiguration (HO command) message from the DU of the corresponding donor node 200 (source donor node).

The mobile IAB node 300M recognizes that the connection destination is the intermediate IAB node 300S upon connecting to the intermediate IAB node 300S. For example, the mobile IAB node 300M may recognize that the connection destination is the intermediate IAB node 300S through the following processing.

First, the CU of the donor node 200 may transmit an F1 message including information indicating that the mobile IAB node 300M has connected to the intermediate IAB node 300S to the IAB-DU of the mobile IAB node 300M. Alternatively, the CU of the donor node 200 transmits the F1 message to the IAB-DU of the intermediate IAB node 300S. The IAB-DU of the intermediate IAB node 300S may transmit an RRC message including the information indicating that the mobile IAB node 300M has connected to the intermediate IAB node 300S to the IAB-MT of the mobile IAB node 300M in response to the reception of the F1 message. The IAB-MT of the mobile IAB node 300M may output the information to an upper node (IAB-DU). As described above, the mobile IAB node 300M may recognize that the connection destination is the intermediate IAB node 300M by receiving the information indicating that the mobile IAB node 300M has connected to the intermediate IAB node 300S from the donor node 200.

Second, the CU of the donor node 200 may transmit an F1 message including the information indicating that the operation as a mobile IAB node is prohibited to the IAB-DU of the mobile IAB node 300M. Alternatively, the CU of the donor node 200 transmits the F1 message to the IAB-DU of the intermediate IAB node 300S. The IAB-DU of the intermediate IAB node 300S may transmit an RRC message including the information indicating that the mobile IAB node 300M is prohibited to operate as a mobile IAB node to the IAB-MT of the mobile IAB node 300M in response to the reception of the F1 message. The IAB-MT of the mobile IAB node 300M may output the information to an upper node (IAB-DU). As described above, the mobile IAB node 300M may recognize that the connection destination is the intermediate IAB node 300S by receiving the information indicating that the operation as a mobile IAB node is prohibited from the donor node 200.

Third, the mobile IAB node 300M may recognize that the connection destination is the intermediate IAB node 300S when the mobile IAB node 300M has connected to a cell to which the mobile IAB node support notification has not been broadcast (or the cell to which the non-support notification of the mobile IAB node 300M has been broadcast). The notification may be broadcast in an SIB.

In step S11, the mobile IAB node 300M stops services for the UE 100 under its control. The IAB-DU of the mobile IAB node 300M may stop transmitting a synchronization signal block (SSB), a master information block (MIB), and/or a system information block (SIB). Alternatively, the mobile IAB node 300M may start broadcasting the MIB including access prohibition (Cell Barred). Alternatively, the IAB-DU of the mobile IAB node 300M may transmit, to the UE 100, a message (for example, an RRC message) including information instructing the UE 100 to discard the MIB and/or the SIB stored in the memory. Alternatively, the UE 100 may discard the MIB and/or the SIB stored in the memory when no SSB, MIB, and/or SIB have been received from the intermediate IAB node 300S (for a certain period of time) without being based on the message.

### (1.2) Second Operation Example

The second operation example will be described.

In the second operation example, the mobile IAB node 300M operates as an intermediate IAB node when having connected to the intermediate IAB node 300S. To be more specific, when a mobile relay node (for example, the mobile IAB node 300M) has connected to an intermediate relay node that is stationary without movement (for example, the intermediate IAB node 300S), predetermined processing is performed. In the predetermined processing of the second operation example, the mobile relay node operates as another intermediate relay node (for example, an intermediate IAB node) that is stationary without movement.

As a result, for example, although the mobile IAB node 300M is restricted from operating (for example, moving) as a mobile IAB node, it operates as an intermediate IAB node. Thus, the mobile IAB node 300M can connect to a network as a normal IAB node, and can continue the services for the UE 100 under the control thereof. Therefore, the mobile IAB node 300M, for example, cannot provide the UE 100 with services associated with movement, but can provide the UE 100 with services not associated with movement. Therefore, the mobile IAB node 300M can appropriately restrict services for the UE 100.

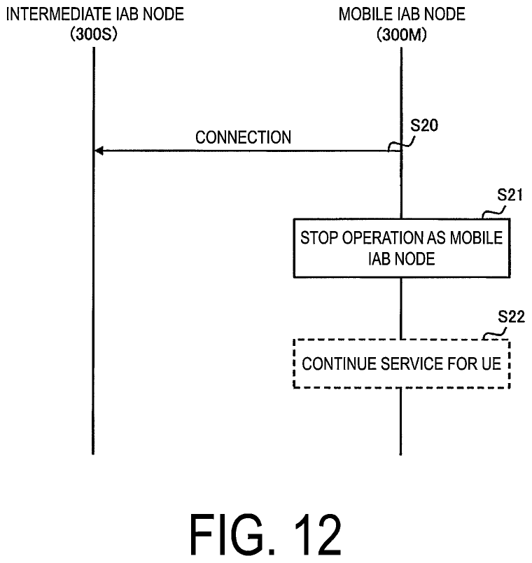

FIG. 12 is a diagram illustrating an operation example according to the second operation example.

As illustrated in FIG. 12, the mobile IAB node 300M connects to the intermediate IAB node 300S in step S20. The example in which the mobile IAB node 300M connects to the intermediate IAB node 300S may be identical to the first operation example. Recognizing that the mobile IAB node 300M has connected to the intermediate IAB node 300S may also be identical to the first operation example.

In step S21, the mobile IAB node 300M stops operating as a mobile IAB node. In other words, the mobile IAB node 300M switches to the operation as an intermediate IAB node when having connected to the intermediate IAB node 300S. Alternatively, when the mobile IAB node 300M connects to the intermediate IAB node 300S and at least one of the following conditions is satisfied, the mobile IAB node 300M may switch to the operation as an intermediate IAB node.
(Condition 1) The mobile IAB node 300M may switch to the operation as the intermediate IAB node 300S only when it is determined that the mobile IAB node itself is not moving (or it is in a stationary state, or has a speed equal to or less than a threshold). The mobile IAB node 300M may utilize, for example, a speed sensor to determine whether it is moving. The mobile IAB node 300M may, for example, determine whether it is moving based on a global navigation satellite system (GNSS) reception signal received by a GNSS receiver.
(Condition 2) The mobile IAB node 300M may switch to the operation of the intermediate IAB node 300S only when there is a connection (for example, an RRC connection) to the UE 100 under its control. The mobile IAB node 300M may not switch to the operation of the intermediate IAB node 300S when there is no connection to the UE 100 under its control.
(Condition 3) The mobile IAB node 300M may switch to the intermediate IAB node 300S upon receiving an instruction from the donor node 200. For example, the mobile IAB node 300M may switch to the operation of the intermediate IAB node 300S in response to reception of a message including information instructing switching to the operation as an intermediate IAB node. This message may be transmitted from the CU of the donor node 200 to the IAB-DU of the mobile IAB node 300M in an F1 message.

The mobile IAB node 300M may operate as an intermediate relay node when at least one predetermined condition among the conditions 1 to 3 is satisfied.

In step S22, the mobile IAB node 300M may continue providing the services for the UE 100. In this case, the mobile IAB node 300M may provide full services for the UE 100. Since the mobile IAB node 300M is operating as an intermediate relay node, it may continue providing the services for the UE 100 in this way. Alternatively, the mobile IAB node 300M may transition to a limited service state to accept emergency calls only. It should be noted that the mobile IAB node 300M in the limited service state is in a state in which services based on an emergency service, an earthquake and tsunami warning system (ETWS), and a commercial mobile alert system (CMAS) can be provided and provision of other services is limited. In the second operation example, the mobile IAB node 300M provides only emergency services to the UE 100.

### Third Operation Example

The third operation example will be described.

In the third operation example, when the mobile IAB node 300M in the RRC idle state or the RRC inactive state receives an emergency call from the UE 100, the mobile IAB node connects to the intermediate IAB node 300S as an intermediate IAB node. To be more specific, when the mobile relay node (for example, the mobile IAB node 300M) in the RRC idle state or the RRC inactive state has received an emergency call from user equipment (for example, UE 100), the mobile relay node connects to another intermediate relay node (for example, the intermediate IAB node 300S) as an intermediate relay node that is stationary without movement (for example, an intermediate IAB node).

Thereby, for example, even in the RRC idle state or the RRC inactive state, the mobile IAB node 300M can accept emergency calls from the UE 100 under its control, and can provide the emergency service to the UE 100 under its control by connecting to the network via the intermediate IAB node 300S. Therefore, the mobile IAB node 300M can appropriately restrict services for the UE 100.

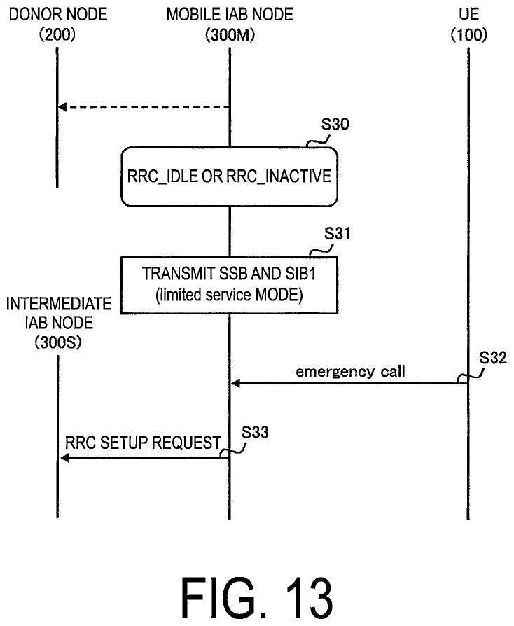

FIG. 13 is a diagram illustrating an operation example according to the third operation example.

As illustrated in FIG. 13, in step S30, the mobile IAB node 300M transitions from the RRC connected state to the RRC idle state or the RRC inactive state. For example, the mobile IAB node 300M transitions to the RRC idle state or the RRC inactive state by receiving an RRC release (RRCRelease) message (an RRC release message that does not include the suspend configuration (suspendConfig) or an RRC release message that includes the suspend configuration) because there has been no traffic for a certain period of time even though the mobile IAB node 300M has connected to the donor node 200.

In step S31, the mobile IAB node 300M transmits the SSB, the MIB and the SIB1 with no connection to the network. An operation state of the mobile IAB node 300M transmitting the SSB, the MIB, and the SIB1 with no connection to the network may be referred to as an initial operation mode. The mobile IAB node 300M is basically in a limited service state.

First, the mobile IAB node 300M may shift to an initial operation mode when configured by the donor node 200. For example, the IAB-DU of the mobile IAB node 300M may shift to the initial operation mode by receiving, from the CU of the donor node 200, an F1 message including information indicating a shift to the initial operation mode when the mobile IAB node 300M has transitioned to the RRC idle state or the RRC inactive state.

Second, the mobile IAB node 300M may shift to the initial operation when the mobile IAB node 300M stops (or if its speed is equal to or lower than a threshold). For example, the mobile IAB node 300M may determine its stop based on a speed sensor. For example, the mobile IAB node 300M may determine its stop based on a GNSS reception signal from the GNSS receiver.

Note that, in the initial operation mode, the mobile IAB node 300M may transmit an SIB other than the SIB1.

In Step S32, the UE 100 makes an emergency call. The UE 100 makes the call by, for example, transmitting an RRC setup request (RRCSetupRequest) message.

In step S33, in response to the reception of the call by the IAB-DU of the mobile IAB node 300M in the RRC idle state, the IAB-MT of the mobile IAB node 300M transmits an RRC setup request message to the IAB-DU of the intermediate IAB node 300S. The IAB-MT of the mobile IAB node 300M may transmit the RRC setup request message including emergency as an establishment cause (EstablishmentCause). Thereafter, the IAB-MT of the mobile IAB node 300M performs the RRC connection establishment procedure with respect to the IAB-DU of the intermediate IAB node 300S to establish an RRC connection, and shifts to the RRC connected state. In response to the reception of the call by the IAB-DU of the mobile IAB node 300M in the RRC inactive state, the IAB-MT of the mobile IAB node 300M transmits an RRC recovery request (RRCResumeRequest) message to the IAB-DU of the intermediate IAB node 300S. The IAB-MT of the mobile IAB node 300M may transmit the RRC recovery request message including emergency as a recovery cause (ResumeCause). Thereafter, the IAB-MT of the mobile IAB node 300M performs the RRC connection recovery procedure with respect to the LAB-DU of the intermediate IAB node 300S to recover the RRC connection and shifts to the RRC connected state.

Note that the mobile IAB node 300M may transmit the RRC setup request message or the RRC recovery request message when the mobile IAB node S300M stops (or when the speed is equal to or less than a threshold).

The mobile IAB node 300M that has transitioned to the RRC connected state can connect to the network via the intermediate IAB node 300S and provide an emergency service to the UE 100.

### OTHER EMBODIMENTS

A program causing a computer to execute each processing operations performed by the UE 100, the gNB 200, or the IAB node 300 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing each processing operations performed by the UE 100, the gNB 200, or the IAB node 300 may be integrated, and at least part of the UE 100 or the gNB 200 may be configured as a semiconductor integrated circuit (a chipset or a System on a Chip (SoC)).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. The embodiments, the operation examples, or the processing operations may be combined as appropriate as long as they are not inconsistent with each other.

First Supplementary Note Features related to the above-described embodiments will be additionally described.

### Supplementary Note 1

A communication control method used in a cellular communication system, the communication control method including performing, by a mobile relay node, predetermined processing when the mobile relay node has connected to an intermediate relay node that is stationary without movement,
wherein the predetermined processing is one of:
stopping, by the mobile relay node, a service for a user equipment under control of the mobile relay node; or
operating, by the mobile relay node, as another intermediate relay node that is stationary without movement.

### Supplementary Note 2

The communication control method described in supplementary note 1, wherein the performing of the predetermined processing includes operating, by the mobile relay node, as the intermediate relay node when a predetermined condition is satisfied, and
the predetermined condition is at least one of:
the mobile relay node being in a stationary state,
a connection being present to the user equipment under the control of the mobile relay node, or the mobile relay node having received an indication from a donor node.

### Supplementary Note 3

The communication control method described in supplementary note 1 or 2, further including accepting, by the mobile relay node, only an emergency call from the user equipment when the mobile relay node operates as the intermediate relay node.

### Supplementary Note 4

A communication control method used in a cellular communication system, the communication control method including connecting, by a mobile relay node in an RRC idle state or an RRC inactive state to another intermediate relay node as an intermediate relay node that is stationary without movement, when receiving an emergency call from user equipment.

### Second Supplementary Note

### 1. Introduction

A new work item for mobile IAB has been approved in RAN #94e.

Specific objects of WI are as follows.
To define migration/topology adaptation procedures to realize IAB node mobility, including inter-donor migration of an entire mobile IAB node (full migration).
To strengthen the mobility of IAB nodes and their UE, including aspects related to group mobility. Optimization to target peripheral UE.
Note that, although touching topics already discussed in Rel-17 or excluded from Rel-17 should be avoided in solutions, feature enhancement specialized in IAB node mobility is an exception.
To mitigate interference due to IAB node mobility, including avoidance of potential collisions of reference signals and control signals (PCI, RACH, etc.).

Note that, at the beginning of the working period, RAN3 and RAN2 should discuss the potential complexity of a scenario in which a mobile IAB node connects to a stationary (intermediate) IAB node, in comparison to a scenario in which a mobile IAB node connects directly to an IAB donor.

In this supplementary note, the complexity in two topology scenarios is analyzed from the perspective of RAN2.

### 2. DISCUSSION

2.1 Scenario

The WID explicitly assumes that a mobile IAB node has no descendant IAB nodes, as follows.

In Rel-18, a mobile IAB supports the following functions applied to FR1 and FR2.
In-band and out-of-band backhaul.
The mobile IAB node has no descendant IAB nodes and provides services only to UE.
The solution is to support HO and DC of the UE.

Since the mobile IAB node provides services only to the UE, that the mobile IAB node is always an access IAB node is clarified.

Proposal 1: RAN2 should make sure that a mobile IAB node is always an access IAB node.

WID states that an intermediate IAB node should be stationary. On the other hand, the question in RAN #96 is whether a mobile IAB node can only connect to an IAB donor or can also connect to an (intermediate) IAB node. Therefore, the two scenarios can be indicated as illustrated in FIGS. 9 and 10, respectively.

Some companies believe that the complexity will reduce if a mobile IAB node connects only to an IAB donor, while others claim that the complexity rather increases due to such a restriction. Thus, the complexity of each scenario will be discussed in the next section.

Observation 1: Complexity needs to be analyzed for a scenario in which a mobile IAB node can connect only to an IAB donor or can also connect to an intermediate IAB node.

### 2.2 Complexity Analysis

### 2.2.1 Deployment and Coverage

In general, Rel-16/17IAB was introduced to aid the efficient establishment of national coverage, particularly to expand FR2 deployment. If a mobile IAB node can connect only to an IAB donor, there will be a lot of coverage holes from the mobile IAB node's point of view because a cell provided by the IAB node is not available to the mobile IAB node.

When the mobile IAB node is disconnected from a network, it is obvious that the service to the UE cannot be continued, and therefore, if there are many coverage holes, many service interruptions directly occur. Assuming that the mobile IAB node is regarded as a network node in the same way as the IAB node of Rel-16/17, such service interruption is not preferred.

In order to realize a mobile IAB in scenario 1, in addition to the existing (or normal) deployment policy, a special deployment policy is required to ensure a coverage suitable for the mobile IAB node. On the other hand, in scenario 2, more flexible deployment is possible. Therefore, there is a possibility that the number of problems in development increases in scenario 1 than in scenario 2.

Proposal 2: RAN2 should agree that, if a mobile IAB node connects only to an IAB donor (scenario 1), service continuity of the mobile IAB node may not be ensured because many coverage holes occur. Therefore, the problem of development increases.

2.2.2 Network Interface Procedure (RAN3 area)

For network interfaces such as F1AP and XNaP, some complexity is expected if a mobile IAB node can also connect to an intermediate IAB node (scenario 2).

A routing configuration (F1AP) requires the IAB donor to update the configuration as a mobile IAB node move into and out of IAB topology. For scenario 2, the IAB donor needs to update the routing configuration of each IAB node in the IAB topology, which may result in a complicated procedure and a waiting time for an F1 reconfiguration.

For migration of a mobile IAB node (XNaP), it is expected that there will be no significant difference between scenario 1 and scenario 2, although full migration between donors of the mobile IAB node and group mobility of the UE will be considered in RAN3. However, in scenario 1, some degree of information exchange is required between the IAB donors in order to transfer, to another donor, the cell that can accept the mobile IAB node, in other words, the cell to which the DU of the IAB donor provides a service. Such information is used by the IAB donor for a measurement configuration and handover determination.

Since a mobile IABWI is driven by RAN3, the complexity of the network interface has already been intended to some degree in comparison to another interface handled in a secondary working group (including RAN2). Whether the network interface can support scenario 2 or whether another working group is instructed to define the mechanism of scenario 1 is up to RAN3 anyway.

Observation 2: If a mobile IAB node connects only to an IAB donor (i.e., scenario 1), the network interface procedure may be simpler. Details are up to RAN3.

2.2.3 Uu interface procedure (RAN2 area)

With respect to a UAU interface, some degree of complexity is expected if a mobile IAB node can connect only to an intermediate IAB node (i.e., scenario 1).

With respect to initial access, it should be discussed whether a mobile IAB node can start an RRC connection establishment procedure for a cell provided by an intermediate IAB node. Although an option that a mobile IAB node is only granted to establish a connection only to a cell provided by an IAB donor DU is conceivable, in this case, how the mobile IAB node can ascertain whether a cell is the cell provided by the IAB donor DU is a question. On the other hand, if a mobile IAB node is regarded as a network node, there is another option that the mobile IAB node can establish a connection to any cell. Thus, a mobile IAB node may also connect to a cell provided by an intermediate IAB node, for example, for an OAM connection. However, since the mobile IAB node cannot connect to such a cell in scenario 1 in that case, if the node connects to a cell provided by the intermediate IAB node, the node is not supposed to operate as a mobile IAB node and may be controlled (i.e., restricted) in some way by the network.

Proposal 3: If a mobile IAB node is only granted to connect to an IAB donor (scenario 1), considering that the mobile IAB node is a network node, the RAN2 should discuss whether it is necessary to restrict the connection attempt by the mobile IAB node only to the IAB donor DU.

It should be discussed whether the mobile IAB node should inform the IAB-donor that initial access is access to the mobile IAB node, as in the existing IAB node indication in Msg5. Such an indication may be necessary regardless of the scenarios, but particularly in scenario 1, the IAB donor needs to determine whether the IAB node can continue to connect to the cell depending on whether the cell is provided by the IAB donor DU or the IAB-DU of the intermediate IAB node. In other words, such an indication is more important in scenario 1.

Proposal 4: In particular, if a mobile IAB node only connects to an IAB donor (scenario 1), RAN2 should discuss whether the mobile IAB node needs to transmit a new indication (such as an indication of the mobile IAB node) in the RRC connection establishment procedure.

Since only fixed IAB nodes were assumed in Rel-16/17, the radio conditions of the backhaul link are considered to be stable. On the other hand, since a mobile IAB node is assumed in Rel-18, an RLF and an RRC reestablishment are not rare cases. When the mobile

IAB node initiates RRC reestablishment, the IAB-MT first performs cell selection. In case of scenario 1, if the mobile IAB node selects a cell provided by the intermediate IAB node, the next RRC reestablishment may fail, or at least the mobile IAB node may not operate as a mobile IAB node after the RRC reestablishment because it cannot connect to the cell provided by the intermediate IAB node. This causes service interruption for the UE. Therefore, scenario 1 is optimized such that the mobile IAB node preferentially selects the cell provided by the IAB donor UE.

Proposal 5: If the mobile IAB node connects only to the IAB donor (scenario 1), RAN2 should discuss whether the RRC reestablishment procedure is optimized such that the mobile IAB node selects a mobile IAB-compatible cell.

On the other hand, if the mobile IAB node can also connect to the intermediate IAB node (scenario 2), no special processing is required because the mobile IAB node can connect to any cell.

Note that functional enhancement for use cases common to both scenarios are not excluded. “No special treatment” is intended to be applied only to comparison between scenarios.

Observation 3: If the mobile IAB node also connects to the intermediate IAB node (scenario 2), the mobile IAB node can connect to any cell (cells provided by the IAB donor DU and the intermediate IAB node), so no special processing is required for access of the mobile IAB node.

### 2.3 Overview

The overview of the above discussion is as follows.

TABLE 1
Summary of complexity of each scenario

| | Scenario 1 | Scenario 2 |
|---|---|---|
| | The mobile IAB node connects to | The mobile IAB node also connects to |
| | the IAB donor only. | the intermediate IAB node. |
| Deployment | Challenging | Minimal effect |
| policy | The coverage provided by the | The mobile IAB node can take |
| | intermediate IAB node cannot be | advantage of the existing coverage. |
| | used. | |
| F1 complexity | Minimal effect | Complex |
| | | The routing setting needs to be |
| | | updated for each IAB node in |
| | | topology. |
| Xn complexity | No big difference in scenarios. | No big difference in scenarios. |
| Uu complexity | Complex | Minimal effect |
| | It may be necessary to limit or | No special handling of the mobile |
| | optimize access attempts of the | IAB node is assumed. |
| | mobile IAB node. | |

As shown in Table 1, there are advantages and disadvantages in the scenarios. Scenario 1 is superior in terms of F1 complexity, and scenario 2 is superior in terms of deployment policy and Uu complexity. Scenario 2 is somewhat desirable, especially from the viewpoint of RAN2. However, the final decision may be made by the major working group, namely RAN3.

Proposal 6: Although the adoption of the mobile IAB node also connecting to the intermediate IAB node (i.e. scenario 2) will have less impact on the specification of RAN2, the final decision should be entrusted to RAN3.

1. A communication control method used in a cellular communication system, the communication control method comprising performing, by a mobile relay node, predetermined processing when the mobile relay node has connected to a network that supports no mobile relay node,
wherein the predetermined processing is one of:
stopping, by the mobile relay node, a service for a user equipment under control of the mobile relay node; or
operating, by the mobile relay node, as another relay node that is stationary without movement.

2. The communication control method according to claim 1, wherein
the performing of the predetermined processing comprises operating, by the mobile relay node, as an intermediate relay node that is stationary without movement when a predetermined condition is satisfied, and
the predetermined condition is at least one of:
the mobile relay node being in a stationary state;
a connection being present to the user equipment under the control of the mobile relay node; or
the mobile relay node having received an indication from a donor node.

3. The communication control method according to claim 1, further comprising accepting, by the mobile relay node, only an emergency call from the user equipment when the mobile relay node operates as an intermediate relay node having stopped without movement.

4. A communication control method used in a cellular communication system, the communication control method comprising
connecting, by a mobile relay node in an RRC idle state or an RRC inactive state, to another intermediate relay node as an intermediate relay node that is stationary without movement, when receiving an emergency call from a user equipment.

5. A mobile relay node comprising:
a controller configured to, when the mobile relay node is in an RRC idle state or an RRC inactive state, connect to another intermediate relay node as an intermediate relay node that is stationary without movement, when receiving an emergency call from a user equipment.
